(19) United States
(12) Patent Application Publication
(10) Pub. No.: US 2013/0131977 A1
(43) Pub. Date: May 23, 2013

(54) SYSTEM AND METHOD FOR PROVIDING OPTIMIZED MAPPING AND TRAVEL

(71) Applicants: Charles L. Dickson, Georgetown, MA (US); Myles G. Baxter, Prescott, AZ (US)

(72) Inventors: Charles L. Dickson, Georgetown, MA (US); Myles G. Baxter, Prescott, AZ (US)

(21) Appl. No.: 13/455,061

(22) Filed: Apr. 24, 2012

Related U.S. Application Data
(60) Provisional application No. 61/561,709, filed on Nov. 18, 2011.

(51) Int. Cl. G01C 21/36

(52) U.S. Cl. 701/428

(57) ABSTRACT

A system and method for optimized mapping and travel to multiple destinations and a system and method for providing optimized mapping, locating, and viewing of real properties for sale. The system and method for mapping, locating, and viewing real properties for sale may include the ability to track service providers so that property information provided by certain agents/brokers can be electronically affirmed and acknowledged by buyers who utilize the system and method.

### CROSS-REFERENCE TO RELATED APPLICATIONS

This application claims priority to provisional patent application having Ser. No. 61/561,709, filed Nov. 8, 2011, which is herein incorporated by reference in its entirety.

### FIELD OF INVENTION

The present invention is generally directed to a system and method for optimized mapping and travel to multiple destinations and more specifically directed to a system and method for providing optimized mapping, locating, and viewing of real properties for sale. In addition the system and method for mapping, locating, and viewing real properties for sale may include the ability to track service providers so that property information provided by certain agents/brokers can be electronically affirmed and acknowledged by buyers who utilize the system and method.

### BACKGROUND OF THE INVENTION

There are many situations in which individuals find themselves in a position where they need to locate and travel to multiple destinations. For example, drivers driving multiple passenger vehicles such as airport shuttles must pick up several passengers at several different locations before transporting them to the airport. Those individuals having to make deliveries to multiple destinations and those individuals having to provide services to multiple locations must locate and travel to several destinations. In addition, other individuals may have to travel to several locations to pick up different items or products for their businesses and still others may spend their leisure time trying to track down items sold at garage sales or through electronic bulletin boards. Therefore, having the ability to create the most efficient or direct route that includes all of one's requires or desired destinations can save a great deal of time and money.

Although programs do exist which allow a user to enter multiple destinations and then obtain a most direct route which includes all of those destinations, these programs require a physical address or a geographic location of at least a city and state. However, many times an individual may be out on the road when they need to utilize multiple location mapping and therefore may not be starting from any known address or location, In addition, an individual may not have immediate access to an exact address but may instead have other identifiers or information that relate to a destination. In these instances, there is a need for a system and method for optimized mapping and travel to multiple destinations where one can use their current location (which can be easily determined via GPS) as the starting point for traveling to multiple destinations and a route to the multiple destinations can be created using alternate destination identifiers, i.e. available destination identifiers other than physical addresses or geographical location information.

Another area of use where direct route mapping can save both time and money is in the sale of real estate. Many times, buyers are not familiar with the areas in which they are searching for real estate. In addition, although one could enter multiple physical addresses of selected properties one at a time into a GPS enabled mobile device, this is time consuming and there is an increased likelihood that you will make mistakes in entering lengthy addresses. Moreover, although it may provide an overall route to the selected properties, it would not provide detailed information about the selected properties while traveling the route. Information about the selected properties would have to be printed out ahead of time and physically carried along or pulled up separately on a mobile device with wireless connection capabilities while traveling the route. Furthermore, in viewing properties of interest, it would be advantageous to be able to create electronic notes on each property in an orderly and organized manner while viewing each of the properties. It would also be advantageous and convenient to be provided with a sectioned component of the direct route map—i.e. just a map and directions from a property where viewing has been completed to the next property on the route. Accordingly, there is a need for a system and method for providing optimized mapping, locating and viewing of properties for sale which requires minimum input to create a most direct route of all desired properties starting from a user's physical location. In addition, there is a need for such a direct route where the direct route also includes detailed property information for each property on the route and the ability to create notes on each of the properties while viewing the properties.

### SUMMARY OF THE INVENTION

The present invention provides a system and method for providing optimized mapping and travel to multiple destinations. In one exemplary embodiment, the system generally includes a host server, a GPS enabled device with a user interface for accessing the host server and inputting two or more separate destinations, one or more external databases in communication with the host server via a network, and a processor for determining the user's location from the user's GPS enabled device, determining the exact geographical location of the two or more separate destinations, mapping a most direct route to each of the separate destinations starting from the user's location, and transmitting at least one of a map of the route and written directions for the route to a viewing screen of the user's GPS enabled device. The system may also include a memory coupled to the processor for storing digital data, an application program stored in the memory and accessible by the processor for directing processing of data by the processor, and one or more internal databases for storing direct route maps, data relating to destinations mapped, and user notes relating to the destinations.

The processor may transmit a plurality of selection options on the user interface of the user's GPS enabled device which correspond to the arrival of the user at each of the separate destinations and the departure of the user from each of the separate destinations so that a user can systematically and efficiently complete the route. The processor may also transmit at least one selection option on the user interface of the user's GPS enabled device enabling the user to enter and save user notes relating to any one of the separate destinations on the most direct route. The separate destinations that are inputted using the user interface of the user's GPS enabled device may include a physical address, a name of an establishment, a property identifier number, a crossing of two street names, a phone number, a name of an institution, a name of an entity, and/or any number that is used to identify a destination or location.

In one exemplary embodiment of the method of the present invention for providing optimized mapping and travel to multiple destinations, the method includes the steps of determining a location of a user through a GPS enabled device in communication with a network and a server/processor, receiving two or more destinations entered by a user via the user interface on the GPS enabled device, determining an exact geographical location associated with each of the two or more destinations by accessing at least one database in communication with the server/processor via the network, mapping a most direct route to each of the exact geographical locations associated with the two or more destinations using the user's location as the starting point, and transmitting a map and/or written directions to the user's GPS enabled device for the most direct route.

The method may also include one or more of the following steps: receiving an indication from the user's GPS enabled device that the user has arrived at the exact geographical location of the first destination on the most direct route, enabling a user to enter and save user notes relating to the destination at which the user has indicated his/her arrival by utilizing the user interface of the user's GPS enabled device, and receiving an indication from the user's GPS enabled device that the user has departed from the first destination. The method may further include the steps of a) transmitting a map and/or written directions to the exact geographical location of the next destination on the most direct route, b) receiving an indication from the user's GPS enabled device that the user has arrived at the exact geographical location of the next destination on the most direct route, c) enabling the user to enter and save user notes relating to the property at which the user has indicated his/her arrival by utilizing the user interface on the user's GPS enabled device, and d) receiving an indication from the user's GPS enabled device that the user has departed from the most recent destination at which the user has indicated his/her arrival. Steps a) through d) may then be repeated until receiving an indication from the user's GPS enabled device that the user has departed from the last property on the most direct route.

The present invention also provides a system and method for providing optimized mapping, locating, and viewing of properties for sale. In one exemplary embodiment, the system generally includes a host server, a GPS enabled device having a user interface for accessing the host server and inputting one or more property identifiers relating to separate properties for sale, one or more external databases in communication with the host server via a network; and a processor for determining the user's location from the user's GPS enabled device, determining the geographical location of the properties from the property identifiers, mapping a most direct route to each of the properties starting from the user's location, and transmitting a map of the route and/or written directions for the route to a viewing screen of the user's GPS enabled device. The processor performs different processing steps by accessing and utilizing data from the external databases and data input by the user using the user interface of the user's GPS enabled device via the network through the server. The processor can determine the location of the user by accessing the positional data transmitted and received to and from one or more global positioning satellites. The processor can also determine the geographical locations of each of the properties input as property identifiers by the user by accessing external databases relating to the property identifiers. For example, if a user enters Multiple Listing Service (MLS) numbers as property identifiers, the processor can access the MLS database to identify the physical property address that correlate with the MLS numbers and determine the geographical location of the physical addresses. The processor can also map a most direct route to each of the geographical locations relating to the MLS numbers starting from the user's geographical location and transmit a map of the route and/or written instructions for the route to the user's GPS enabled device. The system may also include one or more internal databases for storing properties mapped, direct route maps, properties viewed, listing data and information relating to properties mapped and/or viewed, and user notes relating to properties mapped and/or viewed.

The processor may transmit a plurality of selection options on the user interface of the user's GPS enabled device which correspond to the arrival and of the user at each of the separate properties and the completion of the user's viewing of each of the separate properties to enable the user to systematically complete the route. The processor may also transmit at least one selection option on the user interface of the user's GPS enabled device enabling the user to enter and save user notes relating to any one of the separate properties being viewed. In addition, the processor may transmit property listing information, pictures, and/or video tours relating to each of the separate properties to the user's GPS enabled device.

The property identifiers entered by the user may be any number, symbol, indicator, code, letter string, etc. that is associated with a property for sale and stored on a database. For example, the property identifier can be, but is not limited to, an MLS number or an Assessor's Parcel Number (APN).

The present invention also includes a method for providing optimized mapping, locating, and viewing of properties for sale which, in one exemplary embodiment, includes the steps of determining a location for a user through a GPS enabled device in communication with a network and a server/processor, receiving one or more property identifiers entered by a user utilizing a user interface on the GPS enabled device, determining a geographical location associated with each of the one or more property identifiers by accessing at least one external database in communication with the server/processor via the network, mapping a most direct route to each of the geographical locations associated with the one or more property identifiers using the user's location as a starting point, and transmitting a map of the route and/or written directions for the route to the user's GPS enabled device. In addition, the method for providing optimized mapping, locating, and viewing of properties may also include one or more of the following steps: a) receiving an indication from the user's GPS enabled device that the user has arrived at a geographical location of a first property on the most direct route; b) transmitting property listing information, pictures, and/or video relating to the property at which the user had indicated his/her arrival, c) enabling the user to enter and save user notes relating to the property at which the user has indicated his/her arrival by utilizing a user interface on the user's GPS enabled device, d) receiving an indication from the user's GPS enabled device that the user has completed viewing of the property at which the user previously indicated his/her arrival, e) transmitting a map and/or written directions to the geographical location of a next property on the most direct route, f) and receiving an indication from the user's GPS enabled device that the user has arrived at the geographical location of the next property on the most direct route. Furthermore, steps a) through g) listed above may be repeated until receiving an indication from the user's GPS enabled device that the user has completed viewing of a last property on the most direct route. The method for providing optimized mapping, locating, and viewing of properties may also include the step of storing properties mapped, properties viewed, data relating to the mapped and/or viewed properties, and/or user notes relating to the properties to an internal database in communication with the server/processor.

The present invention is also directed to a handheld device that includes a memory, a program application, an external drive for receiving stored information wherein the stored information includes a most direct route map to two or more properties and a user interface for viewing the stored information and inputting data. The program application guides a user to visit the two or more properties and enables the user to enter and save user created information relating to the two or more properties. The stored information may also include data relating to the two or more properties.

The present invention also includes a handheld device having a memory, a program application, wireless access capabilities for accessing one or more external database through a network, and a user interface for inputting two or more property identifiers. The program application guides a user to visit two or more property locations associated with the two or more property identifiers via a direct route map and enables the user to enter and save user created information relating to the two or more properties.

### BRIEF DESCRIPTION OF THE DRAWINGS

The figures illustrate various embodiments of the present invention by way of example, and not by way of limitation. Embodiments of the present invention may include part or all of the features shown in one of these figures, or may include features from two or more figures. Embodiments of the present invention may also include features described in the specification, or elements of features described in the specification. Furthermore, embodiments of the present invention may include features that would be familiar to a person of ordinary skill in the art having studied this document. Thus, a more complete understanding of the present invention may be derived by referring to the detailed description and claims when considered in connection with the drawing figures. Where like reference numbers refer to similar elements throughout the figures, and

FIG. 1 is a block diagram of an exemplary embodiment of a system for providing optimized mapping and travel to a plurality of destinations in accordance with the present invention;

FIG. 2 is a flowchart of an exemplary embodiment of a method for providing optimized mapping and travel to a plurality of destinations in accordance with the present invention;

FIG. 3 is a block diagram of an exemplary embodiment of a system for providing optimized mapping, locating, and viewing of properties for sale in accordance with the present invention;

FIG. 4 is a flowchart of an exemplary embodiment of a method for providing optimized mapping, locating, and viewing of properties for sale in accordance with the present invention;

FIG. 5 is an exemplary screen shot showing a map of the most direct route as it appears on a GPS enabled device in accordance with the system and method of the present invention for providing optimized mapping, locating, and viewing of properties for sale;

FIGS. 6-9 are a series of exemplary screen shots showing exemplary selection options as they appear on the user interface of a GPS enabled device in accordance with the system and method of the present invention for providing optimized mapping, locating, and viewing of properties for sale;

FIG. 10 is a block diagram of an exemplary embodiment of a handheld device (and options for downloading information to the handheld device) which includes a program for optimizing mapping, locating, and viewing of properties which also enables a user of the device to enter personal notes (user created information) relating to the properties the user views;

FIG. 11 shows an exemplary top plan view of the exemplary handheld device shown in FIG. 10; and

FIG. 12 is a flowchart of an exemplary embodiment of a method for providing optimized mapping, locating, and viewing of properties including note taking after viewing the various properties using a preprogrammed handheld device.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing data; a GPS enabled device with a user interface for accessing the host server and inputting data via a network, a memory coupled to the processor for storing data; an application program stored in the memory and accessible by the processor for directing processing of data by the processor; a plurality of databases, and at least one display device coupled to the processor and memory via the network for displaying information derived from data processed by the processor or data retrieved from the plurality of databases. Various databases used herein may include external databases and/or internal databases. External databases may include, but are not limited to, property identifier numbers such as, for example, a Multiple Listing Service (MLS) which assigns an MLS number to properties for sale and an Assessor's Parcel Numbers (APS) which are assigned to land that is for sale, maps for determining the location of positional data entered and received from global positioning satellites, maps for determining physical addresses and direct routes, maps showing locations for names of establishments, maps showing streets, phone number listings which correlate to property addresses, maps showing locations for names of institutions, and maps showing locations for names of entities. Internal databases may include, but are not limited to, properties mapped, properties viewed, data relating to properties mapped and/or viewed, and/or user notes relating to the properties, etc. As those skilled in the art will appreciate, a user's GPS enabled device may include a mobile operating system (Blackberry OS, iOS, Symbian OS, webOS, Windows Phone, etc.) as well as various conventional support software and drivers typically associated with mobile computing. The GPS enabled device may include any suitable smartphone, tablet, notebook, PDA, or other mobile device. Mobile operating systems combine the features of a personal computer operating system with touchscreen, cellular, Bluetooth, WiFi, GPS mobile navigation, camera, video camera, speech recognition, voice recorder, music player, Near field communication, personal digital assistant (PDA), and other features. The mobile computing device has access to a network. In an exemplary embodiment, access is through a network or the Internet through a commercially-available web-browser software package.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse, touchscreen, keypad, and/or any suitable communication or data input modality. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

As used herein, “electronic acknowledgement of service”, “electronic proof of service” or “proving service” refers to causing a user who is given access to the system and method of the present invention to acknowledge the service provider who gave them access or permitted their access so that a sale of a property that was mapped and/or viewed utilizing the system and method of the present invention is attributed to the proper realtor/broker.

The system contemplates uses in association with web services, utility computing, pervasive and individualized computing, security and identity solutions, autonomic computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system and method of the present invention for providing optimized mapping, locating and viewing of properties for sale as well as the system and method for providing optimized mapping and travel to multiple destinations by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the user interface of a user's GPS enabled device. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the customer, client, broker/realtor, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The GPS enabled mobile device of a user is equipped with mobile broadband capabilities by utilizing a wireless data carrier, USB adapter, PC Card, Express Card, or wireless mobile hotspots. Access to the program application(s) relating to the system and method of the present invention for providing optimized mapping, locating and viewing of properties for sale and the system and method of the present invention for providing optimized mapping and travel to multiple destinations may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for users of GPS enabled devices connecting through a web server. Firewall may reside in varying configurations including Stateful Inspection, Proxy based and Packet Filtering among others. Firewall may be integrated within a web server or any other CMS components or may further reside as a separate entity.

The GPS enabled devices discussed herein may provide access to a suitable mobile website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a website having web pages or screen faces. The term “web page” or :screen face” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789.234). The web server retrieves the appropriate web pages or screen faces and sends the data or applications for the web pages or screen faces to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page or screen face such as, for example, free text entry using a keyboard or touchscreen, selection of menu items, check boxes, option boxes, and the like.

The system and method may be described herein in terms of functional block components, screen shots or screen faces, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VB Script or the like.

As used herein, the term “user”, “consumer”, “customer”, or “buyer” may be used interchangeably and the terms “merchant”, “realtor”, “broker”, or “service provider” may be used interchangeably with each other, and each shall mean any person, entity, machine, hardware, software or business. It is further noted that other participants may be involved in some phases of the system, such as an intermediary entity or institution, but these participants are not shown.

Each participant is equipped with a GPS enabled device and/or other computing device in order to interact with the system and facilitate use of the systems and methods of the present invention. The customer or user has a GPS enabled mobile device such as a smartphone, notebook, netbook, PDA and the like. The service provider has a computing unit implemented in the form of a computer-server, although other implementations are contemplated by the system. The external databases may be connect to or associated with one or more computing centers which may be in the form of a main frame computer, a mini-computer, a PC server, a network of computers located in the same or different geographic locations, or the like. Moreover, the system contemplates the use, sale or distribution of any goods, services or information over any network having similar functionality described herein.

The service provider's computer and the computers associated with external databases may be interconnected via a second network, referred to as a payment network if the systems and methods of the present application are provided in mobile application formats to be purchased by users. The payment network which may be part of certain mobile applications represents existing proprietary networks that presently accommodate transactions for credit cards, debit cards, and other types of payment. The payment network is a closed network that is assumed to be secure from eavesdroppers.

An “account” or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account.

As will be appreciated by one of ordinary skill in the art, the systems of the present invention may be embodied as a customization of an existing system, an add-on product, upgraded software, a stand alone system, a mobile application, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots or screen faces, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

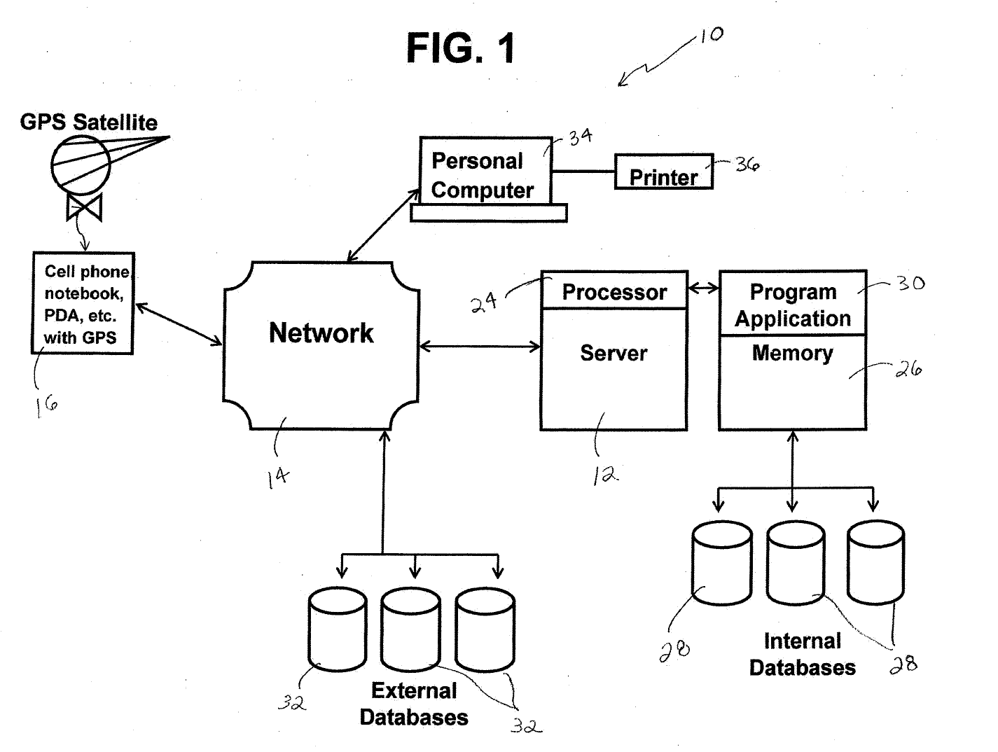

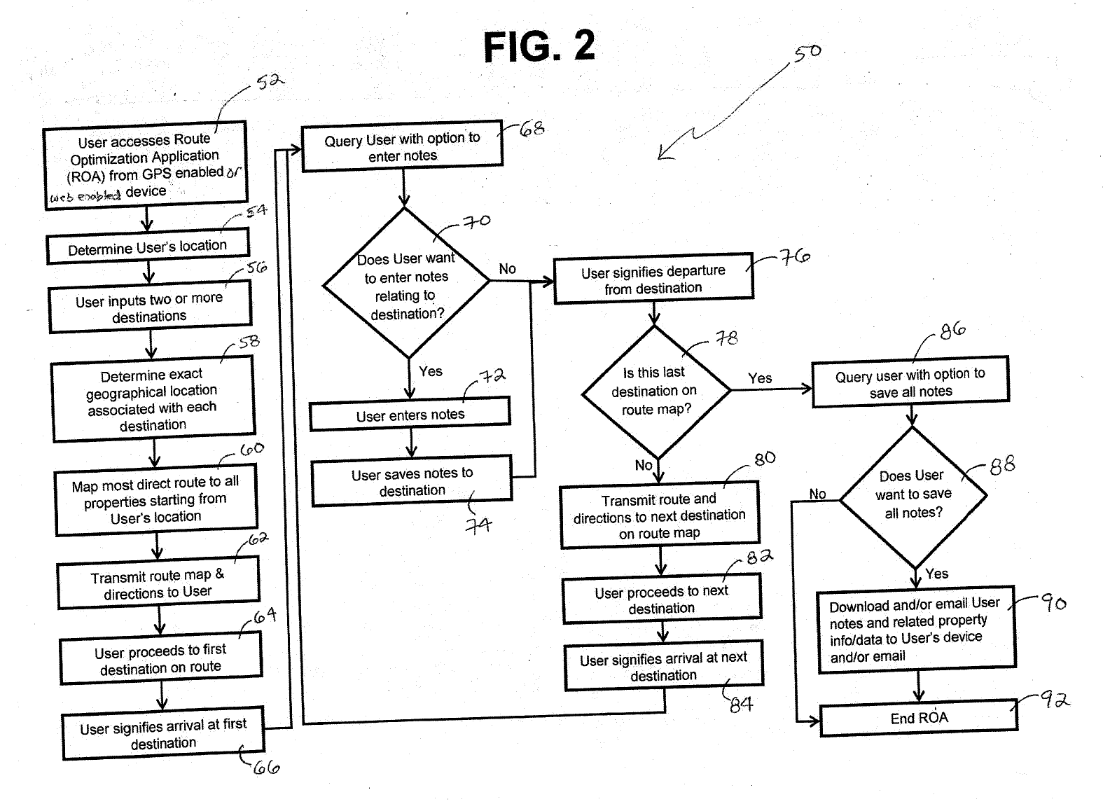

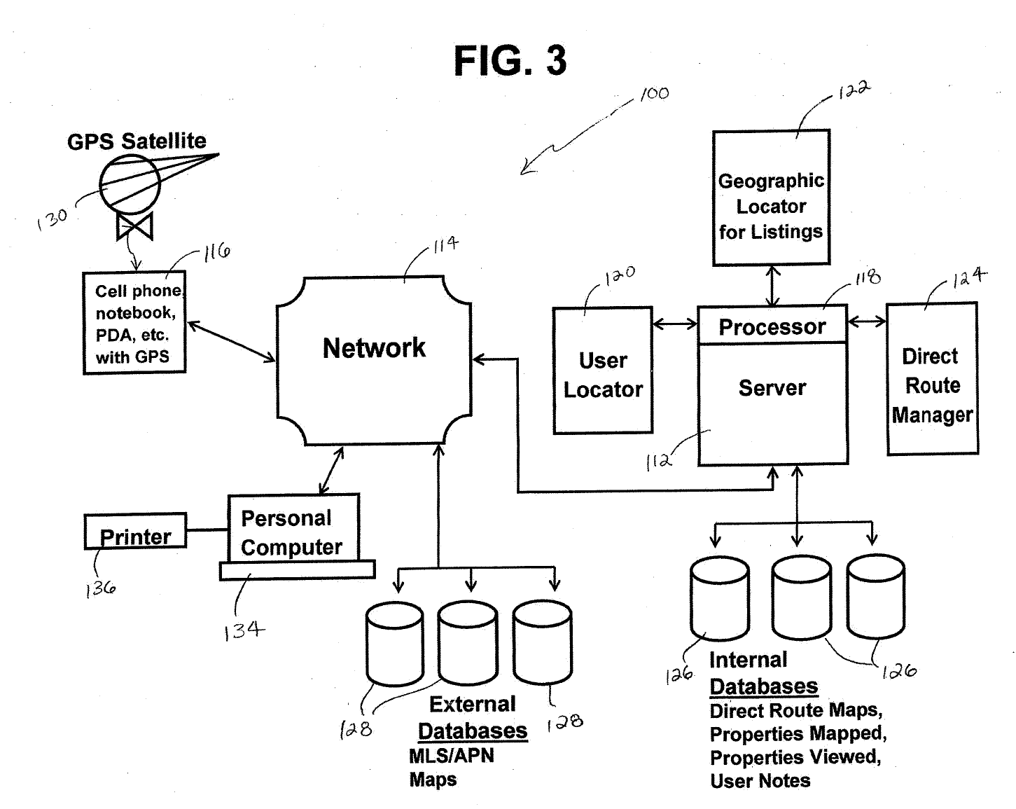

Referring now to FIGS. 2 and 4-9 the process flows and screenshots depicted are merely embodiments and are not intended to limit the scope of the invention as described herein. For example, the steps recited in any of the method or process descriptions may be executed in any order and are not limited to the order presented. It will be appreciated that the following description makes appropriate references not only to the steps and user interface elements depicted in FIGS. 2 and 4-9, but also to the various system components as described above with reference to FIGS. 1 and 3.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, mobile application screen faces or screen shots, prompts, etc. Practitioners will appreciate that the illustrated steps described herein may comprise in any number of configurations including the use of windows, webpages, web forms, popup windows, mobile application screen faces or screen shots, prompts and the like. It should be further appreciated that the multiple steps as illustrated and described may be combined into single webpages, windows, and/or mobile application screen faces or screen shots but have been expanded for the sake of simplicity. In other cases, steps illustrated and described as single process steps may be separated into multiple webpages, windows, and/or mobile application screen faces or screen shots but have been combined for simplicity.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

Turning now to the Figures, FIG. 1 shows a block diagram of an exemplary embodiment of a system 10 for providing optimized mapping and travel to multiple destinations in accordance with the present invention. System 10 includes a host server 12 that is accessible over a network 14, such as, for example, the internet, an intranet, or any other type of network, and a GPS enabled mobile device 16 having a user interface for accessing host server 12 through network 14. GPS enabled user device 16 may include any number of communication tools including, but not limited to, notebooks, smartphones, netbooks, and personal digital assistants. System 10 also includes processor 24 for processing the data input by users via the user interface of the GPS enabled mobile device 16 through network 14 and memory 26 for storing the processed data. A plurality of internal databases 28 may be associated with memory 26 to store the processed data and program application 30, containing instructions for processing the data, may also be stored in memory 26. System 10 also includes a plurality of external databases 32 which contain data that can be accessed through the network 14 by the server 12 and/or processor 24 for processing by the processor 24. Examples of external databases include, but are not limited to, property identifier numbers such as, for example, a Multiple Listing Service (MLS) which assigns an MLS number to properties for sale and an Assessor's Parcel Numbers (APS) which are assigned to land that is for sale, maps for determining the location of positional data entered and received from global positioning satellites, maps for determining physical addresses and direct routes, maps showing locations for names of establishments, maps showing streets, phone number listings which correlate to property addresses, maps showing locations for names of institutions, and maps showing locations for names of entities. Internal databases 28 may include, but are not limited to, properties and/or locations mapped, properties and/or locations viewed, data relating to the properties and/or locations mapped and/or viewed, and/or user notes relating to the properties and/or locations. A personal computer 34, laptop computer, electronic notebook, or the like may be used to access the internal databases 18 via the network 14 so that a user can print out data and information stored in the internal databases 28 with a printer 36 that is in communication with the personal computer 34, laptop computer, electronic notebook, etc.

A flowchart of an exemplary embodiment of a method 50 for providing optimized mapping and travel to a plurality of destinations in accordance with the present invention is shown in FIG. 2. In method 50, a user first accesses the program application (which can also be known as the route optimization application (ROA)) from a GPS enabled device or any cellular phone or smartphone device that is capable of identifying a user's location in step 52. The user's location may be identified or determined in step 54 via one or more satellites using a GPS system or via one or more cell phone towers that are capable of determining a cell phone or smartphone user's location. Next, in step 56, the user inputs two or more destinations that they want to visit and the destinations may be inputted by inputting a variety of identifiers which relate to the destinations such as, for example, actual physical addresses, customer identification numbers which relate to a customer locations, customer names which relate to a customer locations, customer reference numbers which relate to customer locations, phone numbers which correlate to property addresses, names of institutions, names of entities, and names of businesses—all of which relate to locations or physical addresses. The exact geographical locations associated with each of the destinations is then determined in step 58 by accessing external databases that relate to the inputted identifiers associated with the destinations and the most direct route to all of the destinations starting from the user's location is then determined and mapped in step 60. In addition, a user could enter the location of the first destination he is starting from as the starting point instead of having a GPS enabled device, or cellular phone or smart phone device identify his/her physical location as the starting point. The route map and directions are then transmitted to the user in step 62 so that the user can easily follow them on the user's mobile device and the user proceeds to the first destination on the route in step 64. Once the user arrivers at the first destination on the route, the user signifies his/her arrival at the first destination in step 66 by inputting their arrival via an interface on the user's mobile device. For example, there may be a button that can be selected by a user's touch that the program presents on the interface of the user's mobile device so that the user can easily touch the button to indicate their arrival at the first destination. Once the user arrives at the first destination, the program application query's the user in steps 68 and 70 via the user's mobile device as to whether the user wants to enter any notes relating to the destination. If the user does want to enter personal notes relating to the destination, the user does so in step 72 via the user's mobile device and the user then saves their personal notes in step 74 which are saved to an internal database for later access by the user. Once the user notes are saved in step 74, or if the user does not want to enter any user notes in step 70, the user signifies his/her departure from the destination in step 76 by inputting their departure via the interface on the user's mobile device much like they indicated their arrival at the destination.

It will be understood by those skilled in the art that the mobile device which is used during method 50 may include any number of devices that can be easily transported and accessed when one is traveling from destination to destination such as, for example, a cell phone, a smartphone, an electronic notebook, and a laptop computer, any one of which may be GPS enabled or which may be tracked via their use from cell phone towers. Next, in step 78, the program queries the user as to whether or not the destination that they just departed from is the last destination on the route. If the user indicates via the user interface on their device that it is not the last destination, the program transmits the route and directions to the next destination on the route map to the user in step 80 and the user proceeds to the next destination in step 82. Once the user arrives at the next destination on the route map, the user signals his/her arrival at that next destination in step 84 by inputting their arrival via an interface on the user's mobile device. The program then query's the user in steps 68 and 70 via the user's mobile device as to whether the user wants to enter any notes relating to the destination and steps 72 and 74 are then repeated as before if the user does want to enter notes and, once the notes are saved, or if the user does not want to enter any notes, the user is directed back to step 76 in which the user signals their departure from the destination. These steps are all then repeated until the user indicates that they have departed the last destination on the route map in step 78. Once the user has departed the last destination on the route map, the program queries the user as to whether they want to save all user notes in steps 86 and 88. If the user does want to save all user notes then the notes (including one or more of the destinations visited, destination information, and user notes relating to the destinations) are downloaded to an internal database associated with the program and/or e-mailed to the user's e-mail and/or mobile device in step 90 and the user then ends the program in step 92. Alternatively, if the user does not want to save any user notes or destination information, the user proceeds directly to ending the program in step 92 without saving any information or data.

FIG. 3 is a block diagram of an exemplary embodiment of a system 100 for providing optimized mapping, locating, and viewing of properties for sale in accordance with the present invention. System 100 includes a host server 112 that is accessible over a network 114 such as, for example, the internet, an intranet, or any other type of network, and a user device 116 having a user interface for accessing host server 112. User device 116 may include any number of devices that can be easily transported and accessed when one is traveling from destination to destination such as, for example, a cell phone, a smartphone, an electronic notebook, and a laptop computer, etc., any one of which may be GPS enabled or which may be tracked via their use from cell phone towers. FIG. 3 shows one exemplary embodiment of a user device 116 which is a GPS enabled device. A user's GPS enabled device may include a mobile operating system (Blackberry OS, iOS, Symbian OS, webOS, Windows Phone, etc.) as well as various conventional support software and drivers typically associated with mobile computing. The GPS enabled device may include any suitable smartphone, tablet, notebook, PDA, or other mobile device. Mobile operating systems combine the features of a personal computer operating system with touchscreen, cellular, Bluetooth, WiFi, GPS mobile navigation, camera, video camera, speech recognition, voice recorder, music player, Near field communication, personal digital assistant (PDA), and other features.

Server 112 is in communication with a processor 118 which may include, or be in communication with, a number, of program applications for processing data and information. In the exemplary system 100 shown in FIG. 3; processor 118 is in communication with a user locator program application 120, a geographic locator program application 122, and a direct route manager program application 124. Server 112 is also in communication with a number of internal databases 126 and a number of external databases 128 via the network 114. The external databases 128 may include, but are not limited to, property identifier numbers such as, for example, a Multiple Listing Service (MLS) which assigns an MLS number to properties for sale and an Assessor's Parcel Numbers (APS) which are assigned to land that is for sale, maps for determining the location of positional data entered and received from global positioning satellites, maps for determining physical addresses and direct routes, maps showing locations for names of establishments, maps showing streets, phone number listings which correlate to property addresses, maps showing locations for names of institutions, and maps showing locations for names of entities. Internal databases 126 may include, but are not limited to, properties mapped, properties viewed, data relating to properties mapped and/or viewed, and/or user notes relating to the properties, etc. User locator program 120 may utilize external databases 128 such as databases that include maps for determining the location and positional data entered and received from global positioning satellites and GPS satellite 130 to determine the user's location. Geographic locator program application 122 may utilize external databases 128 such as databases for MLS and/or APN listings, for example, that correlate such listings to actual physical addresses or physical locations for mapping while direct route manager program application 124 may utilize external databases 128 such as databases that include maps for determining physical addresses and maps for streets in order to create maps of direct routes for a plurality of locations. In addition, a personal computer 134, laptop computer, electronic notebook, or the like may be used to access the internal databases 126 via the network 114 so that a user can print out data and information stored in the internal databases 126 with a printer 136 that is in communication with the personal computer 134, laptop computer, electronic notebook, etc.

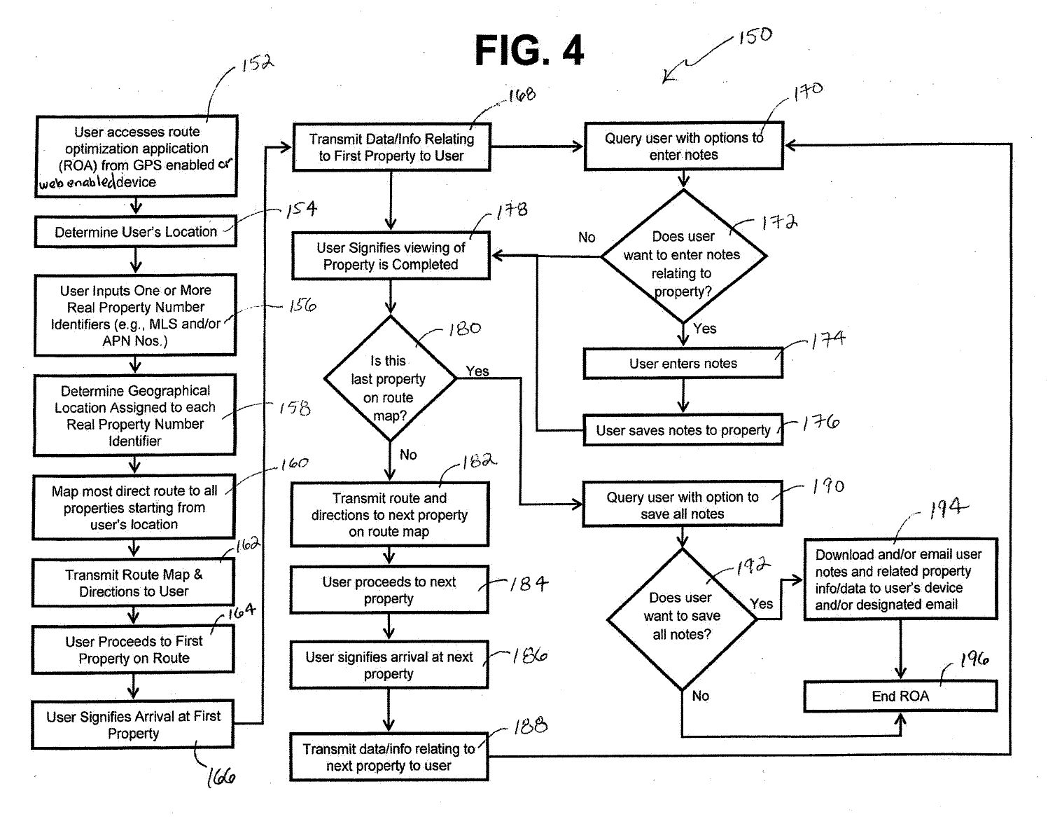

A flowchart of an exemplary embodiment of a method 150 for providing optimized mapping, locating, and viewing of properties for sale in accordance with the present invention is shown in FIG. 4. In method 150, a user first accesses the program application (which can also be known as the route optimization application (ROA)) from a GPS enabled device or any cellular phone or smartphone device that is capable of identifying a user's location in step 152. The user's location may be identified or determined in step 154 via one or more satellites using a GPS system or via one or more cell phone towers that are capable of determining a cell phone or smartphone user's location. Next, in step 156, the user inputs one or more real property identifiers such as, for example, a MLS and/or APN numbers, that they want to visit. The exact geographical locations associated with each of the real property identifiers is then determined in step 158 by accessing external databases that relate to the real property identifiers such as databases for MLS and APN listings and the most direct route to all of the real properties starting from the user's location is then determined and mapped in step 160. The route map and directions are then transmitted to the user in step 162 so that the user can easily follow them on the user's mobile device and the user proceeds to the first real property on the route in step 164. Once the user arrivers at the first real property on the route, the user signifies his/her arrival at the first real property in step 166 by inputting their arrival via an interface on the user's mobile device. For example, there may be a button that can be selected by a user's touch that the program presents on the interface of the user's mobile device so that the user can easily touch the button to indicate their arrival at the first real property. Once the user arrives at the first real property, the program application transmits data and/or information relating to the first real property such as, for example, property listing information, pictures, and/or video in step 168. The program application then query's the user in steps 170 and 172 via the user's mobile device as to whether the user wants to enter any notes relating to the real property. If the user does want to enter personal notes relating to the real property, the user does so in step 174 via the user's mobile device and the user then saves their personal notes in step 176 which are saved to an internal database for later access by the user. Once the user notes are saved in step 176, or if the user does not want to enter any user notes in step 172, the user signifies that his/her viewing of the real property is completed in step 178 by inputting the completed viewing status via the interface on the user's mobile device much like they indicated their arrival at the real property.

Next, in step 180, the program queries the user as to whether or not the real property that they just completed viewing is the last real property on the route. If the user indicates via the user interface on their device that it is not the last real property, the program transmits the route and directions to the next real property on the route map to the user in step 182 and the user proceeds to the next real property in step 184. Once the user arrives at the next real property on the route map, the program application transmits data and/or information relating to the next real property such as, for example, property listing information, pictures, and/or video in step 188. The program application then queries the user in steps 170 and 172 via the user's mobile device as to whether the user wants to enter any notes relating to the real property and steps 174 and 176 are then repeated as before if the user does want to enter notes and, once the notes are saved, or if the user does not want to enter any notes, the user is directed back to step 178 in which the user signals that they have completed viewing the real property. These steps are all then repeated until the user indicates that they have completed viewing the last real property on the route map in step 180. Once the user has completed viewing the last real property on the route map, the program queries the user as to whether they want to save all user notes in steps 190 and 192. If the user does want to save all user notes then the notes (including one or more of the real properties visited, detailed information relating to one or more of the properties, and the user's notes relating to one or more of the properties) are downloaded to an internal database associated with the program and/or e-mailed to the user's e-mail and/or mobile device in step 194 and the user then ends the program in step 196. Alternatively, if the user does not want to save any user notes or property information, the user proceeds directly to ending the program in step 196 without saving any information or data.

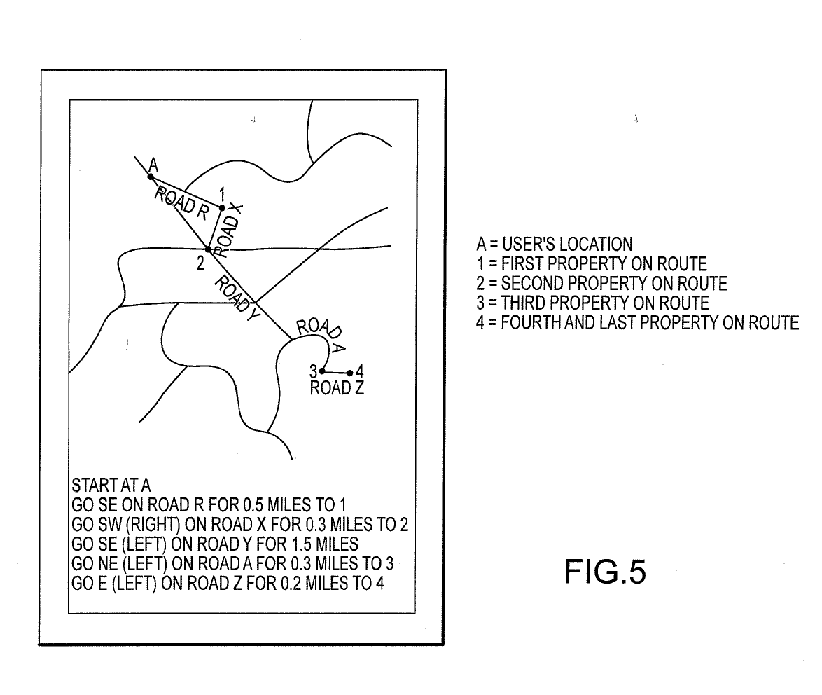

FIG. 5 is an exemplary screen shot showing a map of the most direct route as it appears on a user's mobile device in accordance with the system and method of the present invention for providing optimized mapping, locating, and viewing of properties for sale. As can be seen in FIG. 5, point A relates to the user's location which is determined via the user's device by GPS satellite and/or cell phone tower location, point 1 relates to the first property on the most direct route that has been determined and mapped by the program, point 2 relates to the second property on the most direct route that has been determined and mapped by the program, point 3 relates to the third property on the most direct route that has been determined and mapped by the program, and point 4 relates to the fourth and last property on the most direct route that has been determined and mapped by the program. The user interface of the user's device shows a map with the most direct route along with detailed written directions for the most direct route. It will be understood by those skilled in the art that FIG. 5 shows just one exemplary embodiment of what the program may produce with respect to showing the most direct route map and directions for the same to a user.

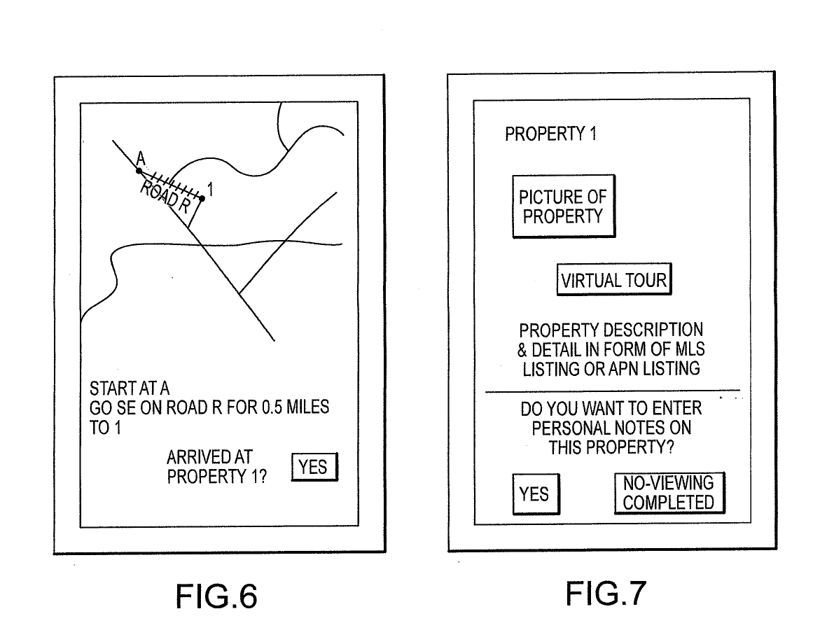

FIGS. 6-9 are a series of exemplary screen shots showing exemplary selection options as they appear on the user interface of a user's device in accordance with the system and method of the present invention for providing optimized mapping, locating, and viewing of properties for sale. For example, FIG. 6 shows the route map from the user's start location to the first property on the most direct route along with written directions for the same and a touch screen election button for the user to elect when the user has arrived at the property. Once the user signals that the user has arrived at the first property by electing “yes” on the touchscreen, the user is presented with the screen shot shown in FIG. 7 which shows the property details for the first property such as the detailed MLS listing, pictures, video, a virtual tour, etc. Alternatively, once a user arrives at a property location, they may utilize their mobile device to scan a QR code (i.e. a quick response code) which would pull up the same information. It is contemplated by this invention that such a QR code could be automatically created when an MLS and/or APN listing is created and the QR code could then be placed on the “For Sale” sign located at the property so that the QR code could be used as part of the system and method outlined by the present invention. The screen shot in FIG. 7 also queries the user as to whether or not the user wants to enter any personal notes and/or observations relating to the property.

If the user does want to enter personal user notes, the user selects “yes” and a screen shot such as the exemplary screen shot shown in FIG. 8 is presented to the user on the user's mobile device. The user can then enter personal notes and observations relating to the property and can then complete viewing the property by saving their notes by electing “yes”. Once the user either 1) enters their notes relating to the property or 2) indicates that viewing is completed and they do not want to enter any notes, an exemplary screen shot like that shown in FIG. 9 is presented to the user which highlights the route that the user will be taking from the first property to the next (second) property along with detailed written directions to the next (second) property. The process for indicating arrival at the property, taking notes relating to the property, and completing the viewing of the property are then repeated until the last property on the route map is viewed.

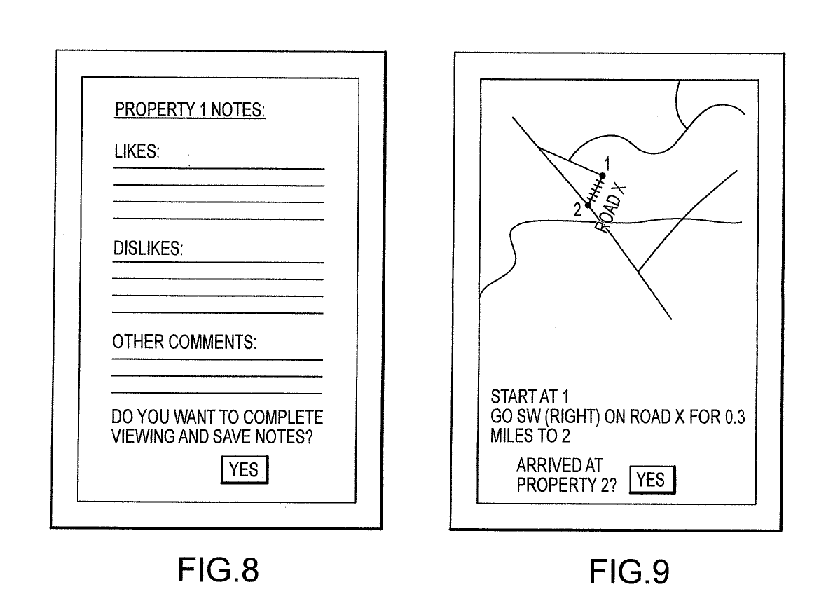

FIG. 10 is a block diagram of an exemplary embodiment of a handheld device (and options for downloading information to the handheld device) which includes a program for optimizing mapping, locating, and viewing of properties which also enables a user of the device to enter personal notes (user created information) relating to the properties the user views. Handheld device 200 includes a memory 202 which can store a property program application (PPA) 204 which functions to guide a user to visit two or more predetermined properties (or locations) via the most direct route and enables the user to enter user created information (personal notes) which relate to the properties (or locations). Property information and a direct route map can be downloaded to the handheld device by inserting an external storage device 212 into an external hard drive 206 which is included as part of the device or by connecting the handheld device to a computing unit 210 (such as a personal computer, for example). The personal computer 210 may utilize databases and/or additional programs via a network 208. Information relating to two or more properties and the most direct route to travel to all of the two or more properties may be downloaded to the device 200. Alternatively, information on two or more properties may be downloaded to the handheld device 200 and the property program application (PPA) 204 may function to map the most direct route to all of the two or more properties. The PPA also enables a user to create and enter user information (such as personal notes) that relate to each of the properties that the user visits. There are numerous applications for such a handheld device. For example, such a device is particularly applicable to the real estate industry as it would enable a realtor or broker to identify a number of predetermined properties that may be of interest to a buyer. Information relating to those predetermined properties can then be downloaded to the handheld device and the device can be given to the buyer who can then utilize the device to visit and view the properties (via a most direct route) at a time when it is convenient for the buyer. The PPA contained in the device also enables the buyer to take notes on the properties that the buyer views and these notes can be downloaded to the device. When the device is returned to the realtor/broker, the realtor/broker will be able to determine which of the properties the buyer viewed and he/she will also be able to see any personal notes the buyer took relating to the properties viewed such as likes, dislikes, etc. This will enable the realtor/broker to further assist the buyer in selecting additional properties for viewing and/or determining which properties of those viewed should be viewed again with the realtor/broker accompanying the buyer. Moreover, the device enables the buyer to view many properties without also requiring the realtor/broker to take up his/her time viewing the properties with the buyer as it is often the case that a buyer wants to get to know an area and what is available before deciding which properties he or she wants to view in detail.

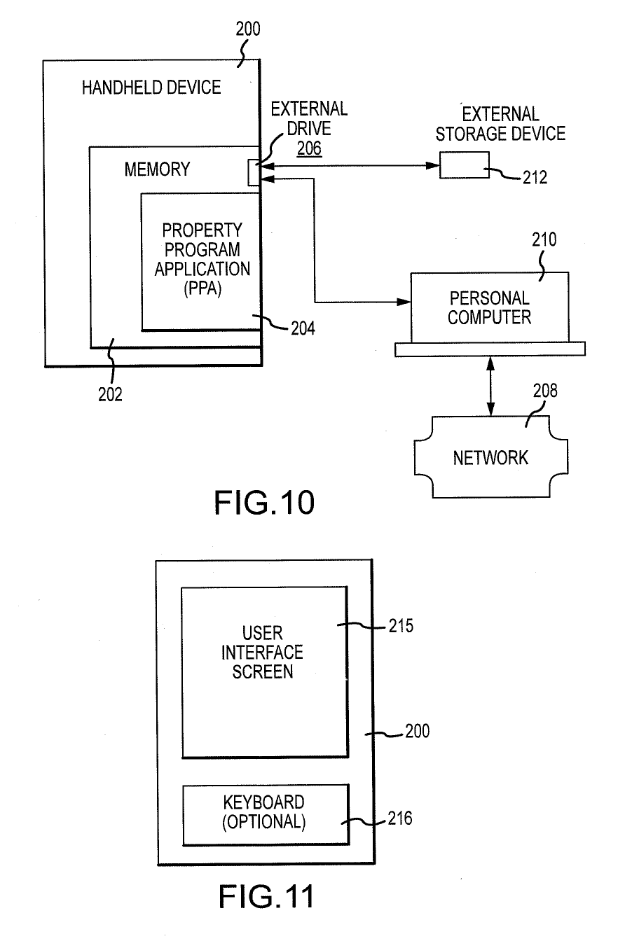

FIG. 11 shows an exemplary top plan view of the exemplary handheld device 200 shown in FIG. 10. The handheld device 200 includes a user interface screen 215 which may comprise a touchscreen. The device 200 may optionally include a keyboard 216 for inputting information or data into the PPA 204.

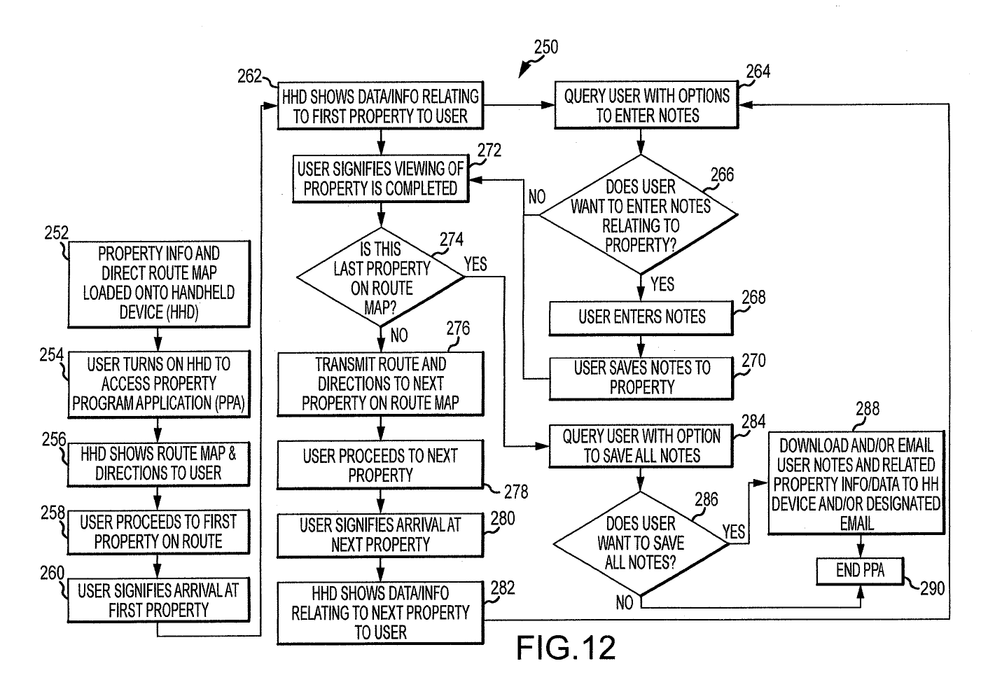

FIG. 12 is a flowchart of an exemplary embodiment of a method 250 for providing optimized mapping, locating, and viewing of properties including note taking after viewing the various properties using a preprogrammed handheld device. In method 250, information relating to two or more properties is loaded onto the handheld device (HHD) in step 252. One or more real property identifiers such as, for example, a MLS and/or APN number may be inputted or actual physical addresses may be inputted. The exact geographical locations associated with each of the real property identifiers may be determined by accessing external databases (which may also be downloaded to the HDD) that relate to the real property identifiers such as databases for MLS and APN listings. The PPA contained within the HHD may determine the most direct route to all of the properties starting from whichever location or property the user wants to start from as long as the starting point is also downloaded to the device. The most direct route may also be determined using external programming and then downloaded to the HHD along with the information relating to the various properties. The user turns on the HHD to access the PPA in step 254 and the HHD then shows the route map and directions to the user in step 256 and the user proceeds to the first property on the route in step 258. Once the user arrivers at the first property on the route, the user signifies his/her arrival at the first property in step 260 by inputting their arrival via an interface on the HHD. For example, there may be a button that can be selected by a user's touch that the program presents on the interface of the HHD so that the user can easily touch the button to indicate their arrival at the first property. Once the user arrives at the first property, the property program application (PPA) transmits data and/or information relating to the first property such as, for example, property listing information, pictures, and/or video in step 262. The PPA then query's the user in steps 264 and 266 via the HHD as to whether the user wants to enter any notes relating to the property. If the user does want to enter personal notes relating to the property, the user does so in step 268 via the HHD and the user then saves their personal notes in step 270 which are saved to an internal database associated with the PPA within the HDD for later access by the user and/or another party who owns or leases the HHD. Once the user notes are saved in step 270, or if the user does not want to enter any user notes in step 266, the user signifies that his/her viewing of the property is completed in step 272 by inputting the completed viewing status via the interface on the HHD much like they indicated their arrival at the property.

Next, in step 274, the PPA queries the user as to whether or not the property that they just completed viewing is the last property on the route. If the user indicates via the user interface on the HHD that it is not the last property, the PPA transmits the route and directions to the next property on the route map to the user in step 276 and the user proceeds to the next property in step 278. Once the user arrives at the next property on the route map and signifies arrival in step 280, the program application (PPA) transmits data and/or information relating to the next property such as, for example, property listing information, pictures, and/or video in step 282. The program application (PPA) then queries the user in steps 264 and 266 via the HHD as to whether the user wants to enter any notes relating to the real property and steps 268 and 270 are then repeated as before if the user does want to enter notes and, once the notes are saved, or if the user does not want to enter any notes, the user is directed back to step 272 in which the user signals that they have completed viewing the real property. These steps are all then repeated until the user indicates that they have completed viewing the last real property on the route map in step 274. Once the user has completed viewing the last real property on the route map, the program queries the user as to whether they want to save all user notes in steps 284 and 286. If the user does want to save all user notes then the notes (including one or more of the real properties visited, detailed information relating to one or more of the properties, and the user's notes relating to one or more of the properties) are downloaded to an internal database associated with the program in the HDD and/or e-mailed to the user's e-mail and/or mobile device if the HDD has wireless access capabilities in step 288. The HHD may or may not have wireless access capabilities. If the HDD does have wireless access capabilities, it can access external databases such as MLS/APN databases, map databases, etc. to carry out some of the functions that may be carried out by the PPA such as determining the physical locations of properties and direct route mapping. The user then ends the program (PPA) in step 290. Alternatively, if the user does not want to save any user notes or property information, the user proceeds directly to ending the program in step 290 without saving any information or data.

It should also be understood that any of the above described systems, apparatus and methods may include the option of skipping properties or locations that are included in the direct route map so that a user can proceed to the next property or location in the route if they do not wan to view or visit a particular property or location.

It should also be understood that information relating to any of the properties or locations that are viewed as part of any of the systems, methods, and/or devices described herein may also be accessed by utilizing a QR (quick response) code that is associated with a property no matter where the QR code may be placed (such as, for example, on a for sale sign, on a paper flyer, or on any other advertising or marketing material associated with the property).

The detailed description of exemplary embodiments of the invention herein shows various exemplary embodiments and the best modes, known to the inventor at this time, of the invention. These exemplary embodiments and modes are described in sufficient detail to enable those skilled in the art to practice the invention and are not intended to limit the scope, applicability, or configuration of the invention in any way. Rather, the following disclosure is intended to teach both the implementation of the exemplary embodiments and modes and any equivalent modes or embodiments that are known or obvious to those reasonably skilled in the art. Additionally, all included figures are non-limiting illustrations of the exemplary embodiments and modes, which similarly avail themselves to any equivalent modes or embodiments that are known or obvious to those reasonably skilled in the art.

Unless specifically noted, it is the Applicant's intent that the words and phrases in the specification and the claims be given the commonly accepted generic meaning or an ordinary and accustomed meaning used by those of ordinary skill in the applicable arts. In the instance where these meanings differ, the words and phrases in the specification and the claims should be given the broadest possible, generic meaning. If any other special meaning is intended for any word or phrase, the specification will clearly state and define the special meaning.

1. A system for providing optimized mapping, locating and viewing of properties comprising:
a host server;
a GPS enabled device having a user interface for accessing the host server and inputting one or more property identifiers relating to separate properties;
one or more external databases in communication with the host server via a network; and
a processor for determining the user's location from the user's GPS enabled device, determining the geographical location of the properties from the property identifiers, mapping a most direct route to each of the properties starting from the user's location, and transmitting at least one of a map of the route and written directions for the route to a viewing screen of the user's GPS enabled device.

2. The system of claim 1 wherein the processor also transmits a plurality of selection options on the user interface of the user's GPS enabled device which correspond to the arrival of the user at each of the separate properties and the completion of the user's viewing of each of the separate properties to enable the user to systematically complete the route.

3. The system of claim 1 wherein the property identifiers each comprise at least one of an MLS number or an APN number associated with a property that is listed for sale.

4. The system of claim 1 wherein the processor also transmits at least one selection option on the user interface of the user's GPS enabled device enabling the user to enter and save user notes relating to any one of the separate properties being viewed.

5. The system of claim 4 further comprising an internal database for storing at least one of direct route maps, properties mapped, properties viewed, data relating to the properties mapped and/or viewed, and user notes relating to the separate properties.

6. The system of claim 1 wherein the processor also transmits at least one of property listing information, pictures, and video relating to each of the separate properties to the user's GPS enabled device.

7. A method for providing optimized mapping, locating, and viewing of properties comprising the steps of:
determining a location of a user through a GPS enabled device in communication with a network and a server/processor;
receiving one or more property identifiers entered by a user utilizing a user interface on the GPS enabled device;
determining a geographical location associated with each of the one or more property identifiers by accessing at least one database in communication with the server/processor via the network;
mapping a most direct route to each of the geographical locations associated with the one or more property identifiers using the user's location as a starting point; and
transmitting at least one of a map and written directions for the most direct route to the user's GPS enabled device.

8. The method of claim 7 further comprising the step of receiving an indication from the user's GPS enabled device that the user has arrived at the geographical location of a property associated with the one or more property identifiers.

9. The method of claim 8 further comprising the step of transmitting at least one of property listing information, pictures, and video relating to the property at which the user has indicated his/her arrival.

10. The method of claim 8 further comprising the step of enabling the user to enter and save user notes relating to the property at which the user has indicated his/her arrival by utilizing a user interface on the user's GPS enabled device.

11. The method of claim 8 further comprising the step of receiving an indication from the user's GPS enabled device that the user has completed viewing of the property at which the user previously indicated his/her arrival.

12. The method of claim 11 further comprising the step of transmitting at least one of a map and written directions to the geographical location of a next property on the most direct route.

13. The method of claim 10 further comprising the step of enabling the user to save all user notes from all properties after receiving an indication from the user's GPS enabled device that the user has completed viewing of all properties on the most direct route.

14. A method for providing optimized mapping, locating, and viewing of properties comprising the steps of:
a. determining a location of a user through a GPS enabled device in communication with a network and a server/processor;
b. receiving one or more property identifiers entered by a user utilizing a user interface on the GPS enabled device;
c. determining a geographical location associated with each of the one or more property identifiers by accessing at least one external database in communication with the server/processor via the network;
d. mapping a most direct route to each of the geographical locations associated with the one or more property identifiers using the user's location as a starting point;
e. transmitting at least one of a map and written directions for the most direct route to the user's GPS enabled device;
f. receiving an indication from the user's GPS enabled device that the user has arrived at the geographical location of a first property on the most direct route;
g. transmitting at least one of property listing information, pictures, and video relating to the property at which the user has indicated his/her arrival;
h. enabling the user to enter and save user notes relating to the property at which the user has indicated his/her arrival by utilizing a user interface on the user's GPS enabled device;
i. receiving an indication from the user's GPS enabled device that the user has completed viewing of the property at which the user previously indicated his/her arrival;
j. transmitting at least one of a map and written directions to the geographical location of a next property on the most direct route;
k. receiving an indication from the user's GPS enabled device that the user has arrived at the geographical location of the next property on the most direct route;
l. repeating steps g through k until receiving an indication from the user's GPS enabled device that the user has completed viewing of a last property on the most direct route.

15. The method of step 14 further comprising the step of storing at least one of route maps, properties mapped, properties viewed, data relating to the properties mapped and/or viewed, and user notes relating to the properties to an internal database in communication with the server/processor.

16. A system for providing optimized mapping and travel to a plurality of destinations comprising:
a host server;
a GPS enabled device having a user interface for accessing the host server and inputting two or more separate destinations;
one or more external databases in communication with the host server via a network; and
a processor for determining the user's location from the user's GPS enabled device, determining the exact geographical location of the two or more separate destinations, mapping a most direct route to each of the separate destinations starting from the user's location, and transmitting at least one of a map of the route and written directions for the route to a viewing screen of the user's GPS enabled device.

17. The system of claim 16 wherein the processor also transmits a plurality of selection options on the user interface of the user's GPS enabled device which correspond to the arrival of the user at each of the separate destinations and the departure of the user from each of the separate destinations to enable the user to systematically and efficiently complete the route.

18. The system of claim 16 wherein the processor also transmits at least one selection option on the user interface of the user's GPS enabled device enabling the user to enter and save user notes relating to any one of the separate destinations on the most direct route.

19. The system of claim 16 wherein the one or more separate destinations comprise at least one of a physical address, a name of an establishment, a property identifier number, a crossing of two street names, a phone number, a name of an institution, and a name of an entity.

20. A method for providing optimized mapping and travel to a plurality of destinations comprising the steps of:
determining a location of a user through a GPS enabled device in communication with a network and a server/processor;
receiving two or more destinations entered by a user utilizing a user interface on the GPS enabled device;
determining an exact geographical location associated with each of the two or more destinations by accessing at least one database in communication with the server/processor via the network;
mapping a most direct route to each of the exact geographical locations associated with the two or more destinations using the user's location as the starting point; and
transmitting at least one of a map and written directions for the most direct route to the user's GPS enabled device.

21. The method of claim 20 further comprising the step of receiving an indication from the user's GPS enabled device that the user has arrived at the exact geographical location of a first destination on the most direct route.

22. The method of claim 21 further comprising the step of enabling the user to enter and save user notes relating to the destination at which the user has indicated his/her arrival by utilizing a user interface on the user's GPS enabled device.

23. The method of claim 22 further comprising the step of receiving an indication from the user's GPS enabled device that the user has departed from the first destination.

24. The method of claim 23 further comprising the steps of:
a. transmitting at least one of a map and written directions to the exact geographical location of a next destination on the most direct route;
b. receiving an indication from the user's GPS enabled device that the user has arrived at the exact geographical location of the next destination on the most direct route;
c. enabling the user to enter and save user notes relating to the property at which the user has indicated his/her arrival by utilizing the user interface on the user's GPS enabled device; and
d. receiving an indication from the user's GPS enabled device that the user has departed from the most recent destination at which the user has indicated his/her arrival.

25. The method of claim 24 further comprising repeating steps a through d until receiving an indication from the user's GPS enabled device that the user has departed from a last property on the most direct route.

26. A handheld device comprising:
a memory;
a program application;
an external drive for receiving stored information wherein the stored information includes a most direct route map to two or more properties; and
a user interface for viewing the stored information and inputting data;
wherein the program application guides a user to visit the two or more properties and enables the user to enter and save user created information relating to the two or more properties.

27. The handheld device of claim 26 wherein the stored information also includes data relating to the two or more properties.

28. A handheld device comprising:
a memory;
a program application;
wireless access capabilities for accessing one or more external databases through a network; and
a user interface for inputting two or more property identifiers;
wherein the program application guides a user to visit two or more property locations associated with the two or more property identifiers via a direct route map and enables the user to enter and save user created information relating to the two or more properties.
